(19) United States
(12) Patent Application Publication
(10) Pub. No.: US 2013/0058602 A1
(43) Pub. Date: Mar. 7, 2013

(54) HYDRODYNAMIC BEARING ASSEMBLY

(71) Applicant: Ki Hyung KIM, Seoul (KR)

(72) Inventor: Ki Hyung KIM, Seoul (KR)

(73) Assignee: SAMSUNG ELECTRO-MECHANICS CO., LTD., Suwon (KR)

(21) Appl. No.: 13/596,711

(22) Filed: Aug. 28, 2012

(30) Foreign Application Priority Data
Sep. 5, 2011 (KR) 10-2011-0089604

(51) Int. Cl. F16C 32/06

(52) U.S. Cl. 384/115

(57) ABSTRACT

There is provided a hydrodynamic bearing assembly structure capable of significantly reducing an increase in current while increasing bearing strength. The hydrodynamic bearing assembly includes: a rotating member including a shaft; a sleeve including a shaft hole so that the shaft is rotatably inserted thereinto; and a plurality of dynamic pressure generation grooves formed in at least one of an outer circumferential surface of the shaft and an inner circumferential surface of the sleeve and formed in upper and lower portions of the shaft or the sleeve in an axial direction so as to generate dynamic pressure in lubricating fluid filled in a bearing clearance formed between the shaft and the sleeve at the time of rotation of the shaft, wherein any one or more of the plurality of dynamic pressure generation grooves has a depth deeper than that of the other dynamic pressure generation groove.

### CROSS-REFERENCE TO RELATED APPLICATIONS

This application claims the priority of Korean Patent Application No. 10-2011-0089604 filed on Sep. 5, 2011, in the Korean Intellectual Property Office, the disclosure of which is incorporated herein by reference.

### BACKGROUND OF THE INVENTION

1. Field of the Invention

The present invention relates to a hydrodynamic bearing assembly, and more particularly, to a hydrodynamic bearing assembly structure capable of significantly reducing an increase in current while increasing bearing strength.

Description of the Related Art

A hard disk drive (HDD), an information storage device, reads data stored on a disk or writes data to the disk using a read/write head.

The hard disk drive requires a disk driving device capable of driving the disk. In the disk driving device, a small-sized spindle motor is used.

The small-sized spindle motor employs a hydrodynamic bearing assembly used therein. A lubricating fluid is interposed between a shaft and a sleeve of the hydrodynamic bearing assembly, such that the shaft is supported by fluid pressure generated in the lubricating fluid.

In this case, two journal bearings are generally provided in upper and lower portions of a shaft or a sleeve in an axial direction so that the shaft may rotate while maintaining stable perpendicularity at the time of the rotation thereof. Grooves of the two journal bearings provided in the upper and lower portions are generally designed to have the same depth.

Here, when bearing strength, directly associated with the perpendicularity of the shaft is intended to be improved, a method of significantly increasing an interval between the two journal bearings to thereby increase a length of the bearing or of reducing an interval between the shaft and the sleeve or a groove depth of the journal bearing may be used.

However, due to the trend toward the miniaturization of the spindle motor, it may be difficult to increase the length of the bearing. Further, in the case of reducing the interval between the shaft and the sleeve or the groove depth of the journal bearing, rotational resistance of the shaft may increase, such that the required power also increases.

Therefore, research into a new bearing assembly structure, capable of suppressing an increase in current while increasing bearing strength, has been urgently demanded.

### SUMMARY OF THE INVENTION

An aspect of the present invention provides a hydrodynamic bearing assembly structure capable of significantly reducing an increase in current while increasing bearing strength of a spindle motor.

According to an aspect of the present invention, there is provided a hydrodynamic bearing assembly including: a rotating member including a shaft; a sleeve including a shaft hole so that the shaft maybe rotatably inserted thereinto; and a plurality of dynamic pressure generation grooves formed in at least one of an outer circumferential surface of the shaft and an inner circumferential surface of the sleeve and formed in upper and lower portions of the shaft or the sleeve in an axial direction so as to generate dynamic pressure in lubricating fluid filled in a bearing clearance formed between the shaft and the sleeve at the time of rotation of the shaft, wherein one or more of the plurality of dynamic pressure generation grooves may have a depth deeper than that of the other dynamic pressure generation groove.

The rotating member may be positioned such that the center of gravity thereof is closer to the dynamic pressure generation groove having a depth greater than to the dynamic pressure generation groove having a lesser depth.

According to another aspect of the present invention, there is provided a hydrodynamic bearing assembly including: a rotating member including a shaft; a sleeve including a shaft hole so that the shaft maybe rotatably inserted thereinto; and first and second dynamic pressure generation grooves formed in at least one of an outer circumferential surface of the shaft and an inner circumferential surface of the sleeve and formed in upper and lower portions of the shaft or the sleeve in an axial direction so as to generate dynamic pressure in lubricating fluid filled in a bearing clearance formed between the shaft and the sleeve at the time of rotation of the shaft, wherein either of the first and second dynamic pressure generation grooves may have a depth greater than that of the other dynamic pressure generation groove.

The rotating member may be positioned such that the center of gravity thereof is closer to the dynamic pressure generation groove having a depth greater than to the dynamic pressure generation groove having a lesser depth.

The lubricating fluid may move downwardly in the axial direction by a resultant force formed by the plurality of dynamic pressure generation grooves due to the rotation of the shaft.

The plurality of dynamic pressure generation grooves may have any one shape of a herringbone shape, a spiral shape, and a helical shape, or may have two or more shapes among the herringbone shape, the spiral shape, and the helical shape.

According to another aspect of the present invention, there is provided a spindle motor comprising the hydrodynamic bearing assembly as described above.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor device including a hydrodynamic bearing assembly according to an embodiment of the present invention;

FIG. 2 is a cut-away perspective view schematically showing the hydrodynamic bearing assembly according to the embodiment of the present invention;

FIG. 3 is a cross-sectional view of a sleeve according to the embodiment of the present invention; and

FIGS. 4A and 4B are graphs showing a depth profile of first and second dynamic pressure generating grooves formed in the sleeve shown in FIG. 3.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, like reference numerals will be used to designate like components having similar functions throughout the drawings within the scope of the present invention.

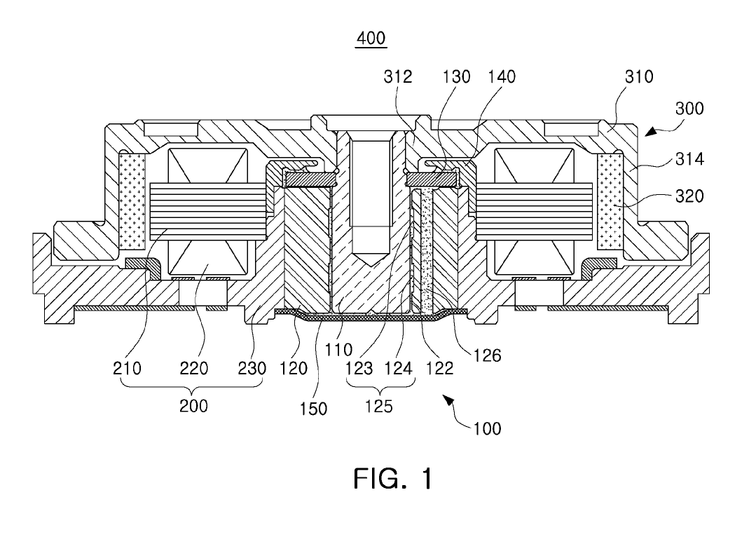

FIG. 1 is a cross-sectional view schematically showing a motor device including a hydrodynamic bearing assembly according to an embodiment of the present invention.

Referring to FIG. 1, the motor device 400 according to the embodiment of the present invention may include a hydrodynamic bearing assembly 100, a stator 200, and a rotor 300.

Specific embodiments of the hydrodynamic bearing assembly 100 will be described in detail below, and the motor device 400 according to the embodiment of the present invention may have all the specific characteristics of each embodiment of the hydrodynamic bearing assembly 100.

The stator 200 may be a fixed structure that includes a winding coil 220 generating electromagnetic force having a predetermined magnitude when power is applied thereto, and a plurality of cores 210 having the winding coil 220 wound therearound.

The core 210 maybe fixedly disposed on an upper portion of the base 230 on which a printed circuit board (not shown) having pattern circuits printed thereon is provided, a plurality of coil holes having a predetermined size may be formed to penetrate through the base 230 so as to expose the winding coil 220 downwardly from an upper surface of the base 230 corresponding to the winding coil 220, and the winding coil 220 maybe electrically connected to the printed circuit board (not shown) in order to have external power supplied thereto.

Here, the base 230 is a component configuring the stator 200 and a hydrodynamic bearing assembly 100 to be described below. Therefore, a detailed description thereof will be provided below.

The rotor 300 may be a rotating structure that is rotatably provided with respect to the stator 200 and may include a rotor case 310 having an annular ring shaped magnet 320 provided on an outer peripheral surface thereof, wherein the annular ring shaped magnet 320 is disposed to correspond to the core 210, having a predetermined interval therebetween.

In addition, as the magnet 320, a permanent magnet generating magnetic force having a predetermined strength by alternately magnetizing an N pole and an S pole thereof in a circumferential direction may be used.

Here, the rotor case 310 may include a fixed part 312 press-fitted onto an upper end of the shaft 110 to thereby be fixed thereto and a magnet support part 314 extended from the fixed part 312 in an outer diameter direction and bent downwardly in the axial direction to thereby support the magnet 320 of the rotor 300.

In addition, the spindle motor may include fixed members and rotating members rotating based on the fixed members. The fixed members may include the stator 200, and a sleeve 120 and a sealing cap 140 provided in a hydrodynamic bearing assembly 100 to be described below. In addition, the rotating members are all components except for the fixed members, and may include the rotor 300, a shaft 110 and a thrust plate 130 in the hydrodynamic bearing assembly 100.

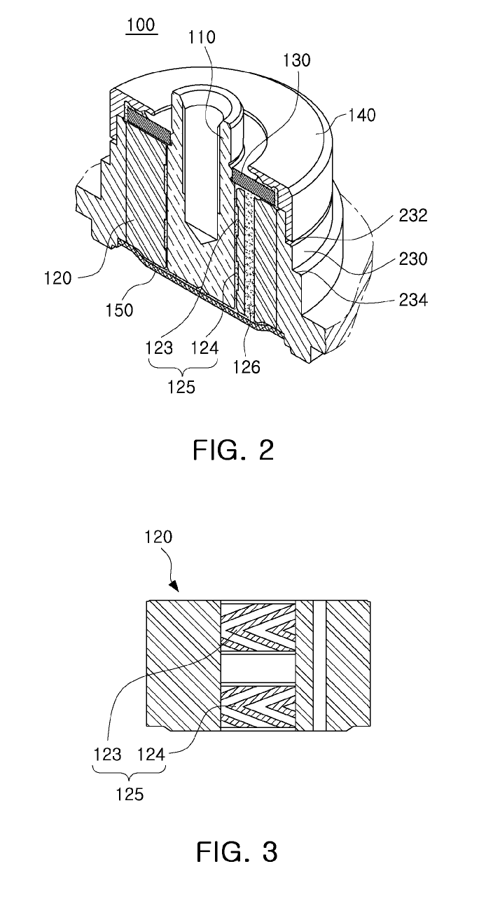

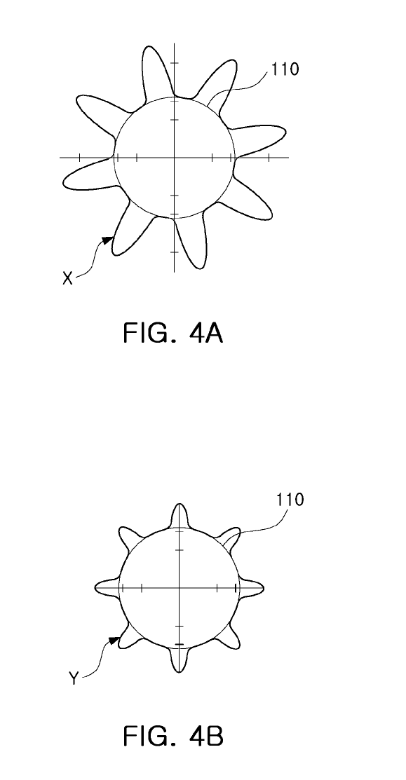

FIG. 2 is a cut-away perspective view schematically showing the hydrodynamic bearing assembly according to the embodiment of the present invention; FIG. 3 is a cross-sectional view of a sleeve according to the embodiment of the present invention; and FIGS. 4A and 4B are graphs showing a depth profile of first and second dynamic pressure generating grooves formed in the sleeve shown in FIG. 3.

The hydrodynamic bearing assembly 100 according to the embodiment of the present invention may include the shaft 110, the sleeve 120, the thrust plate 130, the sealing cap 140, and the base 230.

Terms with respect to directions will be first defined. As viewed in FIGS. 2 and 3, an axial direction refers to a vertical direction based on the shaft 110, while an outer diameter direction or an inner diameter direction refers to a direction toward an outside end of the rotor 300, based on the shaft 110, or a direction toward the center of the shaft 110, based on the outside end of the rotor 300.

The sleeve 120 may support the shaft 110 such that an upper end of the shaft 110 protrudes upwardly in an axial direction, and may be formed by forging Cu or Al or sintering a Cu-Fe based alloy powder or an SUS-based powder.

Here, the shaft 110 may be inserted into a shaft hole 122 of the sleeve 120 so as to have a micro clearance (a bearing clearance) formed therebetween. The micro clearance may befilled with lubricating fluid, and the rotation of the rotor 300 may be more smoothly supported by a dynamic pressure generation groove 125 formed in at least one of an outer circumferential surface of the shaft 110 and an inner circumferencial surface of the sleeve 120.

The dynamic pressure generation groove 125 may be formed in an inner side of the sleeve 120, which is an inner portion of the shaft hole 122 of the sleeve 120, and forms pressure to be deflected toward one side at the time of the rotation of the shaft 110.

However, the dynamic pressure generation groove 125 is not limited to being formed in the inner side of the sleeve 120 as described above, but may also be formed in an outer circumferential portion of the shaft 110. In addition, the number of dynamic pressure generation grooves 125 is not limited.

Further, according to the embodiment of the present invention, the dynamic pressure generation groove 125 may include first and second dynamic pressure generation grooves 123 and 124 that generate dynamic pressure in the lubricating fluid filled in the bearing clearance formed between the shaft 110 and the sleeve 120 at the time of rotation of the shaft 110 and that have any one or more of a herringbone shape, a spiral shape, and a helical shape. Although two dynamic pressure generation grooves are formed for convenience in the accompanying drawings, the present invention is not limited thereto. That is, as described above, the number of dynamic pressure generation grooves is not limited.

The dynamic pressure generation grooves 125 may be formed in upper and lower portions of the sleeve 120 or the shaft 110 in the axial direction, whereby the shaft 110 may rotate while remaining centered.

Here, when it is intended to improve bearing strength directly associated with perpendicularity of the shaft 110, a method of significantly increasing an interval between the first and second dynamic pressure generation grooves 123 and 124, included in the dynamic pressure generation groove 125 to thereby increase a length of the bearing or reducing an interval between the shaft and the sleeve or a groove depth of the journal bearing, may be used.

However, due to the trend toward the miniaturization of the spindle motor, it is difficult to increase the length of the bearing. Further, in the case of reducing the interval between the shaft and the sleeve or the groove depth of the journal bearing, rotational resistance of the shaft increases, such that the entire required current increases.

Therefore, according to the embodiment of the present invention, a structure of a bearing assembly capable of significantly reducing an increase in current while increasing bearing strength is suggested.

That is, at least one of a plurality of dynamic pressure generation grooves 123 and 124 formed in at least one of the shaft 110 and the sleeve 120 may be formed to have a depth deeper than that of the other dynamic pressure generation groove, and the other dynamic generation groove may be formed to have a relatively shallower depth.

In addition, the rotating member may be positioned such that the center of gravity thererof is closer to the dynamic pressure generation groove having a depth greater than to the dynamic pressure generation groove having a lesser depth to relatively increase the bearing strength of the dynamic pressure generation groove positioned to be closed to the center of gravity, whereby overall bearing strength may be increased.

Only depths of some of the plurality of dynamic pressure generation grooves may be increased, such that rotational resistance of the shaft 110 is only partially increased, whereby an increase in current may be significantly reduced.

The dynamic pressure generation grooves formed in pairs will be described in more detail with reference to FIGS. 2 though 4.

That is, any one of first and second dynamic pressure generation grooves 123 and 124 formed in at least one of the shaft 110 and the sleeve 120 may be formed to have a depth deeper than that of the other dynamic pressure generation groove, and the other dynamic generation groove may be formed to have a relatively shallower depth.

In addition, the center of gravity of the rotating member may be positioned to be closer to the dynamic pressure generation groove having a depth greater than to the dynamic pressure generation groove having a shallower depth to relatively increase the bearing strength of the dynamic pressure generation groove positioned to be closed to the center of gravity, whereby the overall bearing strength may be increased.

Only the depths of some of the first and second dynamic pressure generation grooves 123 and 124 may be increased, such that rotational resistance of the shaft 110 is only partially increased, whereby an increase in current may be minimized.

It may be appreciated from FIGS. 4A and 4B that a groove depth is deeper in a groove depth profile X of FIG. 4A than in a groove depth profile Y of FIG. 4B. Although the present invention has described a case in which the dynamic pressure generation groove has a herringbone shape by way of example, the dynamic pressure generation groove may also have a spiral shape or a helical shape.

The sleeve 120 may include a bypass channel 126 formed therein so as to allow upper and lower portions thereof to be in communication with each other to disperse pressure of lubricating fluid in an inner portion of the hydrodynamic bearing assembly 100, thereby maintaining balance in the pressure, and moving air bubbles, or the like, existing in the inner portion of the hydrodynamic bearing assembly 100 so as to be discharged by circulation.

The thrust plate 130 may be disposed on an upper portion of the sleeve 120 in the axial direction and may include a hole corresponding to a cross section of the shaft 110 at the center thereof, wherein the shaft 110 may be inserted into the hole.

Here, the thrust plate 130 may be separately manufactured and then coupled to the shaft 110. However, the thrust plate 130 may be formed integrally with the shaft 110 at the time of manufacturing thereof and may rotate together therewith at the time of the rotation of the shaft 110.

In addition, the thrust plate 130 may include a thrust dynamic groove formed in upper surface thereof, wherein the thrust dynamic groove provides thrust dynamic pressure to the shaft 110.

The thrust dynamic groove is not limited to being formed in the upper surface of the thrust plate 130 as described above, but may also be formed in an inner peripheral surface of a sealing cap 140 to be described below, corresponding to an upper surface of the thrust plate 130.

The sealing cap 140 is a member that is press-fitted onto an upper portion of the thrust plate 130 to allow the lubricating fluid to be sealed between the thrust plate 130 and the sealing cap 140. An outer peripheral surface of a base 230 to be described below may be inserted into the sealing cap 140 to thereby be supported by the sealing cap 140.

The sealing cap 140 may include a protrusion part formed from a lower surface thereof in order to seal the lubricating fluid, which uses a capillary phenomenon in order to prevent the lubricating fluid from being leaked to the outside at the time of the driving of the motor.

The sealing cap 140 may have a larger diameter B in an inner peripheral surface thereof in contact with the base 230 than in a diameter A in an inner peripheral surface thereof contacting an outer peripheral surface of the thrust plate 130 so as to be seated on the upper portion of the sleeve 120 in the axial direction.

This is to allow an outer peripheral surface of the sealing cap 140 and an outer peripheral surface of the base 230 to coincide with each other so as to be in provided in parallel with each other and is consequently used to stably press-fit the core 210 having the coil 220 wound therearound onto the outer peripheral surfaces of the sealing cap 140 and the base 230.

Therefore, the base 230 has an outer peripheral surface shape having different diameters, corresponding to a shape of the sealing cap 140.

Here, the sealing cap 140 is press-fitted onto the outer peripheral surface of the base 230, such that a diameter of the sleeve 120 may be substantially reduced.

This relatively reduces an inner diameter of the core 210 press-fitted into the base 230 to thereby naturally increase a tooth length of the core 210 around which the coil 220 is wound.

Therefore, turns of the coil 220 wound around the core 210 are increased, such that performance and dynamic stability of the hydrodynamic bearing assembly 100 may be improved.

The base 230 may be press-fitted onto the outer peripheral surface of the sleeve 120 to thereby be fixed thereto and may include the core 210 inserted thereinto, wherein the core 210 has the coil 220 wound therearound. In addition, the base 230 may be assembled with the sleeve 120 by applying an adhesive to the inner surface of the base 230 or the outer surface of the sleeve 120.

The outer peripheral surface of the base 230 may include two-stage steps having a diameter increasing in an outer diameter direction and may include the sealing cap 140 and the core 210 each press-fitted onto portions thereof in which the steps are formed.

A first step part 232 may allow the outer peripheral surface of the sealing cap 140 and the outer peripheral surface of the base 230 that the core 210 contacts, to coincide with each other, so as to be parallel with each other, and may stably fix the sealing cap 140 to the base 230.

In addition, a second step part 234 may fixedly support the core 210. A length of the second step part 234 protruding in an outer diameter direction is not limited as long as the core 210 may be stably fixedly supported.

Therefore, since the outer peripheral surface of the base 230 has different diameters and the sealing cap 140 is press-fitted onto the outer peripheral surface of the base 230, a diameter of the sleeve 120 may be reduced as compared to a case in which the sealing cap 140 is press-fitted onto the sleeve 120. As a result, the tooth length of the core 210 may be increased.

A base cover 150 may be coupled to the sleeve 120 at a lower portion thereof in the axial direction, having a clearance therebetween, and may include an outer diameter larger than that of the sleeve 120.

The base cover 150 may receive the lubricating fluid in the clearance between the sleeve 120 and the base cover 150 to thereby serve as a bearing supporting a lower surface of the shaft 110.

Through the above-mentioned embodiments, a bearing assembly capable of significantly reducing an increase in current while increasing the bearing strength of the rotating member in the spindle motor may be provided. In addition, since the structure of the bearing assembly according to the embodiment of the present invention may be simply manufactured through simple modification of a manufacturing scheme, a manufacturing line according to the related art may be used as it is.

As set forth above, according to the embodiments of the present invention, the bearing strength may be increased by a simple scheme without an increase in a bearing length.

In addition, groove depths of some of the journal bearings are adjusted in consideration of the center of gravity of the rotating member to minimize an increase in rotational resistance, whereby an increase in current may be minimized.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a rotating member including a shaft;
a sleeve including a shaft hole, the shaft hole having the shaft rotatably inserted thereinto; and
a plurality of dynamic pressure generation grooves formed in at least one of an outer circumferential surface of the shaft and an inner circumferential surface of the sleeve and formed in upper and lower portions of the shaft or the sleeve in an axial direction so as to generate dynamic pressure in lubricating fluid filled in a bearing clearance formed between the shaft and the sleeve at the time of rotation of the shaft,
any one or more of the plurality of dynamic pressure generation grooves having a depth deeper than that of the other dynamic pressure generation groove.

2. The hydrodynamic bearing assembly of claim 1, wherein the rotating member is positioned such that the center of gravity thereof is closer to the dynamic pressure generation groove having a depth greater than to the dynamic pressure generation groove having a lesser depth.

3. A hydrodynamic bearing assembly comprising:
a rotating member including a shaft;
a sleeve including a shaft hole, the shaft hole having the shaft rotatably inserted thereinto; and
first and second dynamic pressure generation grooves formed in at least one of an outer circumferential surface of the shaft and an inner circumferential surface of the sleeve and formed in upper and lower portions of the shaft or the sleeve in an axial direction so as to generate dynamic pressure in lubricating fluid filled in a bearing clearance formed between the shaft and the sleeve at the time of rotation of the shaft,
either of the first and second dynamic pressure generation grooves having a depth deeper than that of the other dynamic pressure generation groove.

4. The hydrodynamic bearing assembly of claim 3, wherein the rotating member is positioned such that the center of gravity thereof is closer to the dynamic pressure generation groove having a depth greater than to the dynamic pressure generation groove having a shallower depth.

5. The hydrodynamic bearing assembly of claim 1, wherein the lubricating fluid moves downwardly in the axial direction by a resultant force formed in the plurality of dynamic pressure generation grooves due to the rotation of the shaft.

6. The hydrodynamic bearing assembly of claim 3, wherein the lubricating fluid moves downwardly in the axial direction by a resultant force formed in the plurality of dynamic pressure generation grooves due to the rotation of the shaft.

7. The hydrodynamic bearing assembly of claim 1, wherein the plurality of dynamic pressure generation grooves have any one shape of a herringbone shape, a spiral shape, and a helical shape, or have two or more shapes among the herringbone shape, the spiral shape, and the helical shape.

8. The hydrodynamic bearing assembly of claim 3, wherein the plurality of dynamic pressure generation grooves have any one shape of a herringbone shape, a spiral shape, and a helical shape, or have two or more shapes among the herringbone shape, the spiral shape, and the helical shape.

9. A spindle motor comprising the hydrodynamic bearing assembly of claim 1.

10. A spindle motor comprising the hydrodynamic bearing assembly of claim 3.
